(19) United States
(12) Patent Application Publication
(10) Pub. No.: US 2012/0183168 A1
(43) Pub. Date: Jul. 19, 2012

(54) Removable Accessory Systems And Methods

(76) Inventor: Amy M. Humes, Great Barrington, MA (US)

(21) Appl. No.: 13/184,057

(22) Filed: Jul. 15, 2011

Related U.S. Application Data
(60) Provisional application No. 61/364,493, filed on Jul. 15, 2010.

(51) Int. Cl. H04R 1/02; A44B 11/25; B23P 11/00; A44B 99/00

(52) U.S. Cl. 381/334; 24/712; 24/715.3; 24/3.13; 24/595.1; 29/896.41

(57) ABSTRACT

Accessory systems and methods are provided. An accessory may be designed with two loops (such as an elastomeric strap or two elastic loops) attached to the back of a decorative ornament using, for example, an interlocking post. The accessory may be removably attached to footwear. The ornament may rest on the upper part of a shoe, while the two elastic loops secure the ornament by coming together underneath the shoe strap, upper or lace to form a single combined loop and then flipping over the ornament, thereby holding it in place. These accessory ornaments may be moved from shoe to shoe, allowing the wearer to create their own look. In addition, the wearer may change the ornament on the same shoe, changing the look of that one shoe, depending on the chosen ornament. The accessory ornament may be attached to other objects, such as ski poles, helmets, goggles, bike handle bars, zippers, and purses. The accessory ornament may include a media player, speakers and a computer processor to execute the media player and facilitate playback of music.

### RELATED APPLICATION

This application claims the benefit of U.S. Provisional Application No. 61/364,493, filed on Jul. 15, 2010. The entire teachings of the above application are incorporated herein by reference.

### BACKGROUND

Individuals frequently employ any number of fashion accessories. For instance, objects may be adorned with accessories. Shoes, for example, may be accessorized. However, the ornaments are often either affixed permanently or attached to the shoes, for example, by a clip-on or Velcro attachment. For the Velcro system, the consumer typically needs to buy the manufacturers' footwear for the ornament to affix properly. With the clip-on ornaments, the clip-on system is typically not secure, may damage the footwear, and is uncomfortable for the wearer.

### SUMMARY

Accessory systems and methods may be provided for the attachment of an ornament to objects, such as footwear. The accessory may be designed with two loops attached to the back of a decorative ornament. In the footwear implementation, the ornament preferably rests on the upper part of the shoe, while the two loops, which may be implemented in elastic or any type of elastomeric material, secure it by coming together underneath the shoe strap, upper or lace to form a single combined loop and then flipping over the ornament, thereby holding it in place. In this way, aspects of the invention can address such issues asinstability of the ornament by meeting the two loops together to form a single combined loop, which is wrapped around the ornament. This two loop system that forms a single combined loop securely fastens the ornament to the shoe, provides stability from movement, and enables the ornament to be centered and stabilized during and after attachment.

The accessory system may be safe for footwear and comfortable for the wearer. The inventive accessory system may work on most footwear, providing there is a strap, lace or upper portion of the shoe facilitating attachment.

With the present invention, the consumer need not buy a new pair of shoes. The wearer may use the same ornament on a number of different shoes, or a number of different ornaments on the same shoe, to change the look easily. In addition, the footwear accessories created according to the present systems and methods are designed to be comfortable and not damage the shoe.

According to an embodiment of the invention, footwear accessory systems and methods may be provided. A removable apparatus for accessorizing footwear may be provided. The footwear accessory is designed with two elastic loops attached to a coupler at the back of a decorative ornament. An ornament may be provided that is capable of being removably attached to a portion of the footwear (e.g. a shoe strap). The ornament may have a coupler (attachment means) that enables an elastic fastener to attach the ornament to the shoe strap. The coupler may have at least two holes. The elastic fastener may have two elastic loops. The fastener can be threaded through one or more of the holes on the coupler. When pulled through each of the holes, two loops are provided, one on each side of the fastener. The two elastic loops are capable of being wrapped underneath the shoe strap to secure the ornament on the shoe strap.

The accessory ornament may be moved from shoe to shoe, allowing the wearer to create their own look. In addition, the wearer may change the ornament on the same shoe, changing the look of that one shoe, depending on the chosen ornament.

A system of attaching a removable accessory to an item may be provided. An ornament may be removably coupled to a salient portion of the item. The salient portion of the item is capable of receiving the ornament. For example, the item may be a ski pole, and the salient portion of the ski pole may be a portion of it that is capable of receiving the ornament for attachment, such as the handle or strap of the ski pole. The item may be a ski or other helmet, and the salient portion of the helmet may be the goggle retention strap. The item may be goggles, and the salient portion of the goggles may be the head strap. The item may be a purse, and the salient portion may be the strap of the purse. The item may be a bike, and the salient portion may be the handle bars. The item may be a hair accessory, and the salient portion may be a strap of the accessory. The item may be a wearer's body, and the salient portion may be hair or a finger.

The ornament may include a coupler that couples an elastic fastener to the ornament. The coupler may include at least two holes. The fastener includes first and second loops, each loop threaded through one or more of the holes on the coupler. The first and second loops are wrapped underneath the salient portion of the item to form a single combined loop securing the ornament onto the salient portion of the item, such that the first and second loops are joined together to form the single combined loop that is wrapped over the ornament, where the wrapping of the single combined loop over the ornament causes the ornament to be secured to the salient portion of the item. The fastener may be elastic, such that the first and second loops may be elastic loops. The fastener may be an elastomeric strap made from one or more of: molded rubber, silicone or thermoplastic elastomeric material. The coupler may include an interlocking post that secures the fastener to provide a snap fit to attach the ornament to the fastener. The interlocking post may secure the fastener to the ornament without any additional mechanical or chemical fasteners.

The ornament may be operable to receive/interface with any of a plurality of accessories, each accessory having their own respective design. The accessory designs may attach to the face of the ornament.

The ornament may include computer processor and a media player or communication client to facilitate playback of music.

A method of attaching a removable accessory to a shoe may be provided. First and second loops of an elastic fastener may be created by threading the fastener through holes on a coupler attached to an ornament. The fastener may be coupled to a strap of the shoe to facilitate attachment of the ornament to the shoe strap by: wrapping first and second loops under opposite sides of the strap; joining the first and second loops under the strap to form a single combined loop; and pulling the single combined loop over the top of the ornament to secure the ornament to the shoe, whereby the single combined loop stabilizes the ornament on the shoe strap and prevents the ornament from moving to one side of the shoe strap.

A removable apparatus for accessorizing footwear may be provided. An ornament capable of being removably coupled to a portion of a shoe strap may be provided. The ornament may have a coupler configured to couple an elastic fastener to the ornament. The coupler may have two holes for threading the elastic fastener through the coupler. The fastener may include a two loop system including first and second loops, each loop being created as a result of threading the fastener through the respective holes on the coupler. The two loop system may be configured such that the first and second loops are wrapped underneath the shoe strap to form a single combined loop to facilitate securing the ornament to the shoe strap, where the first and second loops are joined together to form the single combined loop. The two loop system may include the single combined loop, which is pulled over the ornament to secure the ornament to the shoe strap.

A removable accessory system may be provided that is integrated with a media player/communications client. An ornament may be removably attached to a salient portion of an item. The salient portion of the item is capable of receiving (accepting) the ornament for attachment. The ornament may have a coupler/coupling means for coupling an elastic fastener to the ornament. The coupler may have at least two holes. The fastener may have first and second loops, each loop threaded through one of the holes on the coupler, where the first and second loops secure the ornament to the salient portion of the item. The ornament may include a media player and a processor configured to execute the media player to facilitate playback of sound files.

The salient portion of the item may be a portion of a handle of a ski pole. The salient portion of the item may be a portion of goggles. The salient portion of the item may be the goggle retention strap attached to a ski helmet. The salient portion of the item may be a handlebar of a bicycle. The salient portion of the item may be a part of the wearer's body.

The first and second loops are joined together to form the single combined loop that is wrapped around the salient portion of the item and over the ornament, where the wrapping of the single combined loop over the ornament causes the ornament to be secured to the salient portion of the item.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a diagram of the top view of the ornament attached to the footwear according to an embodiment of the invention.

FIG. 2 is a diagram of the top view of the ornament with the elastic fasteners attached according to an embodiment of the invention.

FIG. 3 is a diagram of the bottom view of the ornament with the elastic fasteners attached according to an embodiment of the invention.

FIG. 4-1 is a side view showing how the elastic fastener couples to the ornament according to an embodiment of the invention.

FIG. 4-2 shows top and bottom views of ornaments having different diameters according to an embodiment of the invention.

FIG. 4-3 shows a side section of an ornament implemented using upholstery.

FIG. 4-4 is a side section view of an ornament implemented using a fabric top and a metal backing

FIG. 4-5 is a top view of the ornament according to an embodiment of the invention.

FIGS. 4-6 and 4-7 are side views of the ornament with interlocking post on back according to an embodiment of the invention.

FIG. 4-8 is a bottom view of the ornament with interlocking post on the back according to an embodiment of the invention.

FIGS. 4-9 and 4-10 are cross section views of the ornament with interlocking post on back according to an embodiment of the invention.

FIG. 5-1 is a diagram of the ornament placed on top of the footwear, the two elastic loops provided according to an embodiment of the invention.

FIG. 5-2 is a diagram of the left elastic fastener wrapping under the shoe strap according to an embodiment of the invention.

FIG. 5-3 is a diagram of the right elastic fastener wrapping under the shoe strap to align with the left elastic fastener according to an embodiment of the invention.

FIG. 5-4 is a diagram of the left and right elastic fasteners meeting together under the straps of the footwear according to an embodiment of the invention.

FIG. 5-5 is a diagram of the two elastic fasteners (now coupled into one loop) flipping over the ornament according to an embodiment of the invention.

FIG. 5-6 is a diagram showing how the elastic fasteners attach the ornament to the footwear providing a transparent view of the ornament according to an embodiment of the invention.

FIG. 5-7 is a diagram showing the ornament completely attached to the footwear, as though one could see through the ornament according to an embodiment of the invention.

FIG. 6 is a diagram showing a front elevation of the ornament fastened to the footwear according to an embodiment of the invention.

FIG. 7 is a diagram showing a back elevation of the ornament fastened to the footwear according to an embodiment of the invention.

FIG. 8 is a diagram of the ornament attached to the footwear according to an embodiment of the invention.

FIGS. 9-1 through 9-3 are diagrams related to an embodiment in which the ornament includes a media player (or communication client) and a computer processor for executing the same.

### DETAILED DESCRIPTION

A description of preferred embodiments of the invention follows.

Accessory systems and methods are provided. The accessory systems and methods may be implemented for attachment to accessorize another object, such as footwear. The accessory may be designed with two loops attached to the back of a decorative ornament. In the footwear implementation, the ornament preferably rests on the upper part of the shoe, while the two loops, which may be implemented in elastic or any type of elastomeric material, secure it by coming together to form a single combined loop underneath the shoe strap, upper or lace and then flipping over the ornament, thereby holding it in place.

The present invention may be used interchangeably on most types of footwear. These accessory ornaments may be moved from shoe to shoe, allowing the wearer to create their own look. In addition, the wearer may change the ornament on the same shoe, changing the look of that one shoe, depending on the chosen ornament.

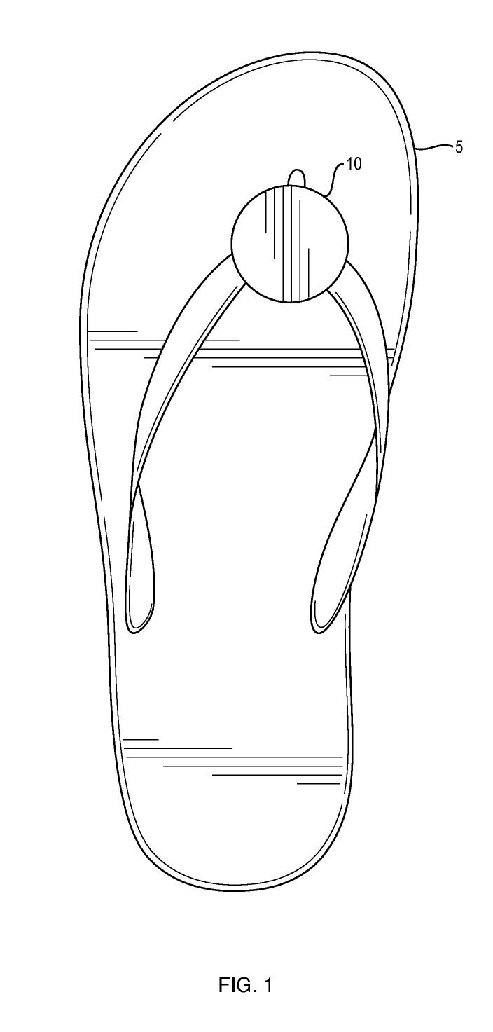

FIG. 1 is a diagram of the top view of the ornament 10 attached to the footwear 5 according to an embodiment of the invention. The ornament 10 is shown removably attached to a thong. The optimal use for present invention in the footwear implementation is on thong (flip flops or sandals) shoes, because the ornament 10 attaches easily and securely to the footwear. The ornament accessory system may also be used on other types of footwear or objects, such as handbags, hair products, zippers, steering wheels, ski poles, personal electronics, etc.

### Plastic Ornament Accessory System

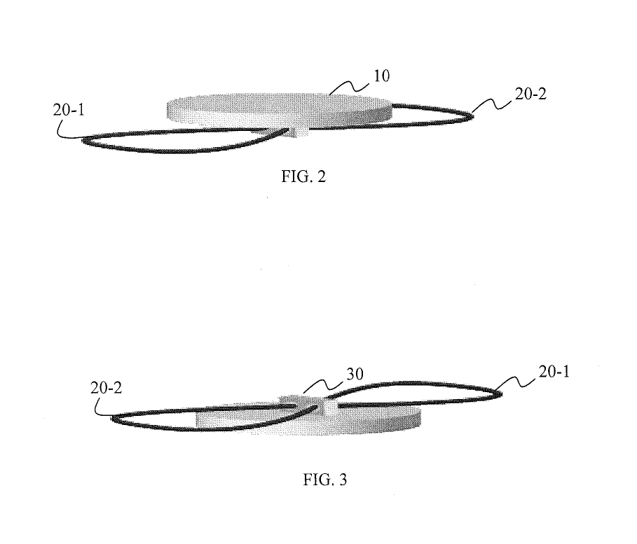

FIG. 2 is a diagram of the top view of the ornament 10 with the elastic fasteners 20-1, 20-2 attached according to an embodiment of the invention. FIG. 3 is a diagram of the bottom (backside) view of the ornament 10 with the elastic fasteners 20-1, 20-2 attached according to an embodiment of the invention. Although a round ornament 10 is shown in plastic, any shape or type of ornament may be used. For example, fabric or plastic flower(s), jewelry, buttons, ribbon bows, etc. may be used as part of the ornament. In the plastic flower implementation, for example, the elastic band may be sewn into the middle of the flower. Similar approaches may be used with the ribbon bow implementations.

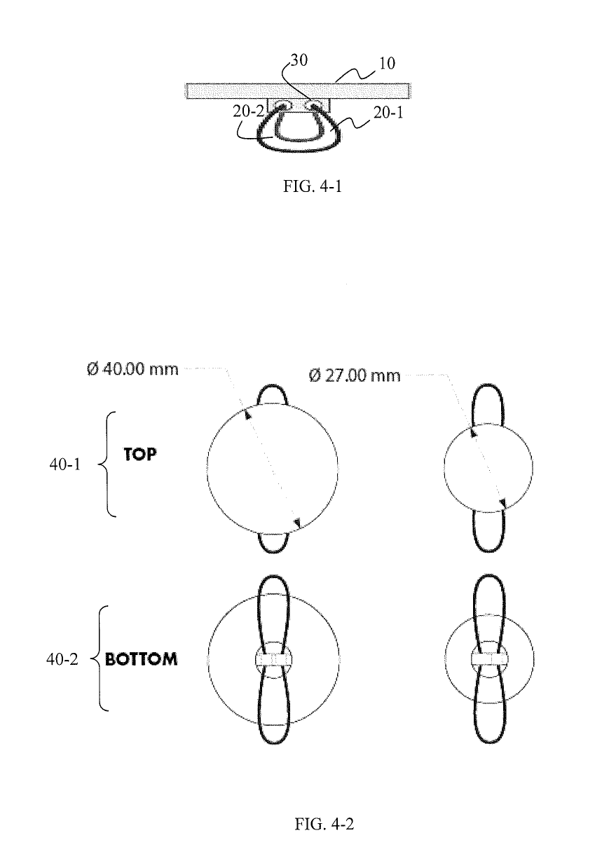

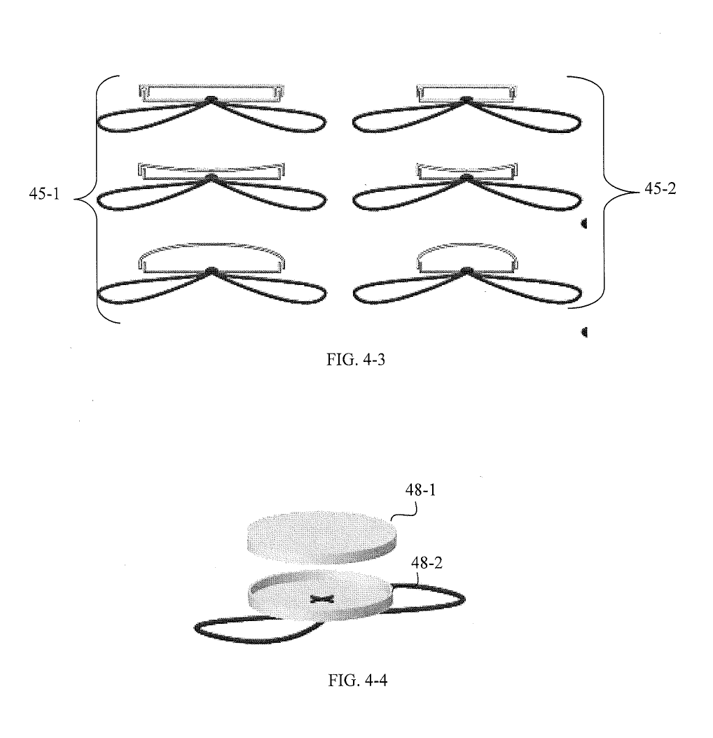

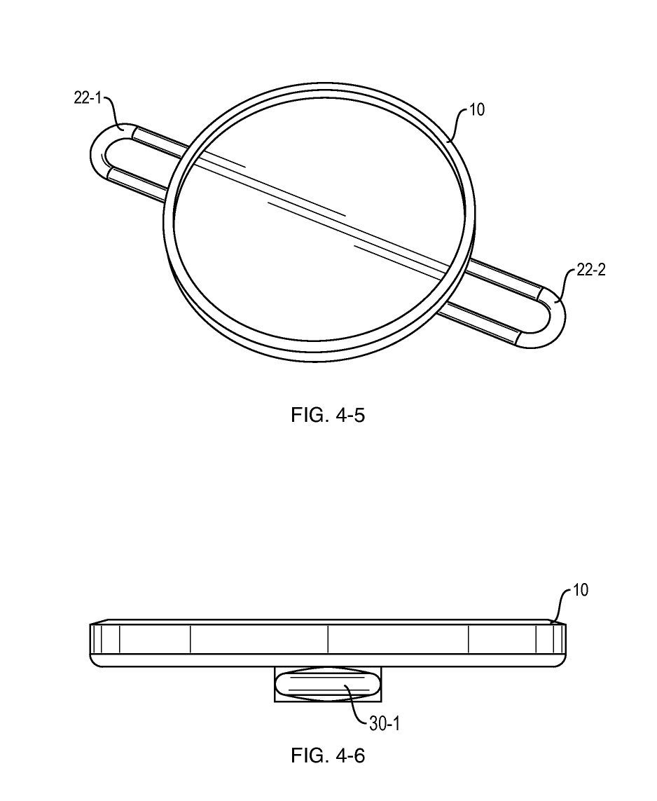

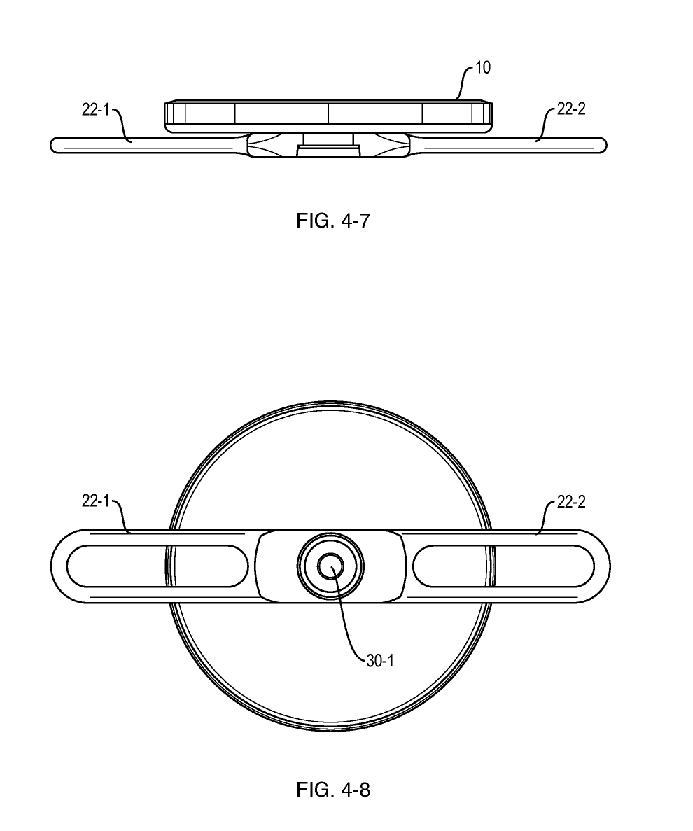

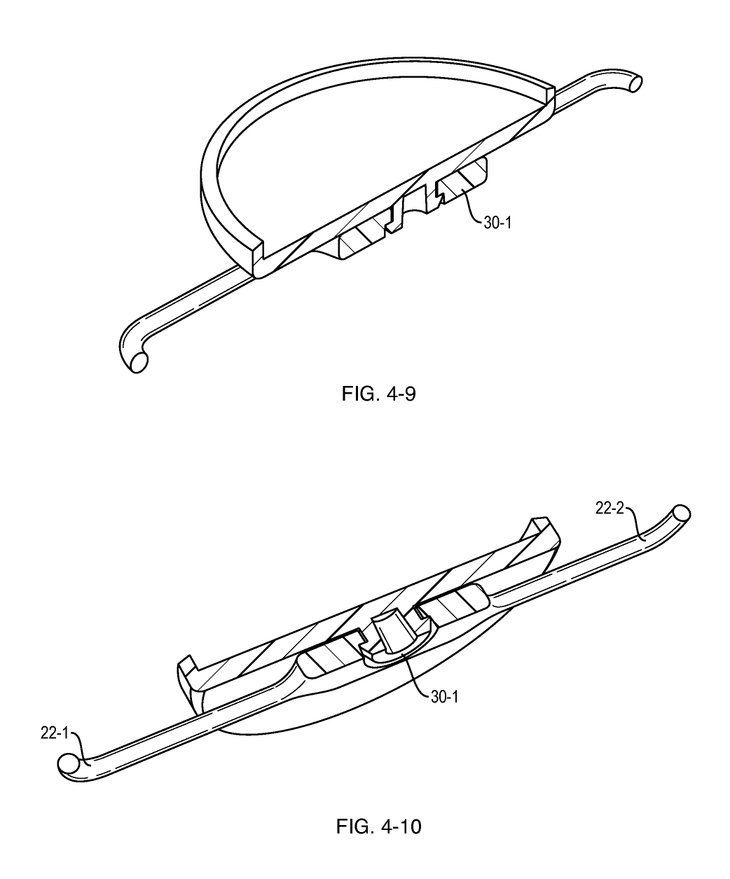

FIG. 4-1 is a side view showing how the elastic fastener couples 30 to the ornament 10 according to an embodiment of the invention. In this embodiment, the elastic is threaded through one hole of the coupler 30 and then back through the other in order to create two permanent elastic loops (or fasteners) 20-1, 20-2 and to permanently secure the elastic fasteners to the ornament. The ornament 10 shown in FIGS. 2, 3, and 4-1 may be made of plastic.

FIG. 4-2 shows top 40-1 and bottom 40-2 views of ornaments having two different diameters according to an embodiment of the invention. Ornaments are shown with a 40mm diameter and a 27 mm diameter. In one example implementation where the ornament is implemented to accessorize footwear, the ornament may have a maximum size (40mm diameter) to ensure ease of comfort of the wearer. Any size ornament may be implemented.

### Fabric Ornament Accessory System

FIG. 4-3 shows side section views of an ornament implemented using upholstery. The ornament is shown with several side section view perspectives. The ornament is depicted as having two different size implementations, one 45-1 being implemented having a 40 mm diameter, and another 45-2 having a 27 mm diameter.

The ornament may have a fabric/upholstery covering with a metal back. FIG. 4-4 is a side section view of an ornament implemented using a fabric top 48-1 and a metal backing 48-2. The fabric/upholstery top 48-1 interconnects with the metal backing 48-2 to provide a secure connection.

### Molded Bezel Ornament Accessory System

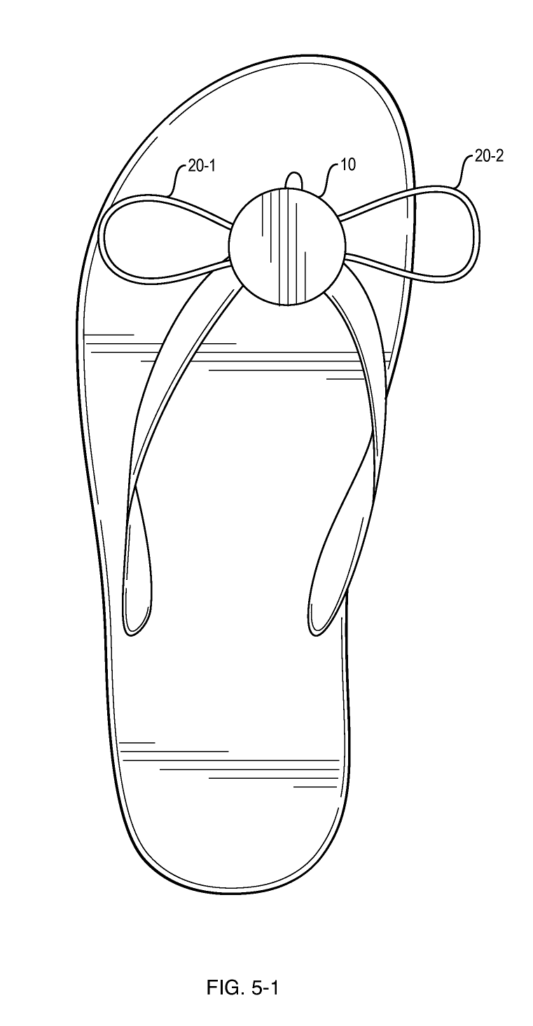

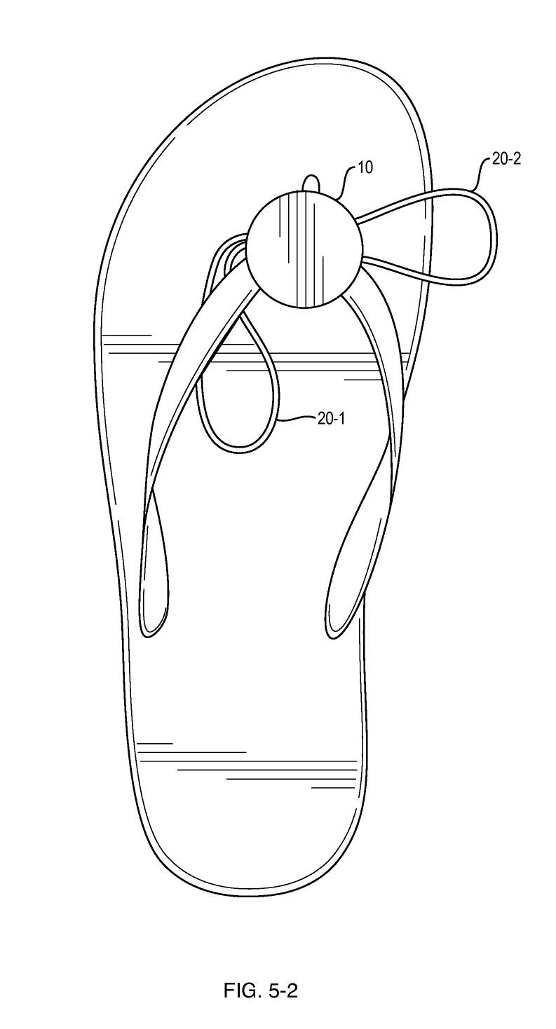

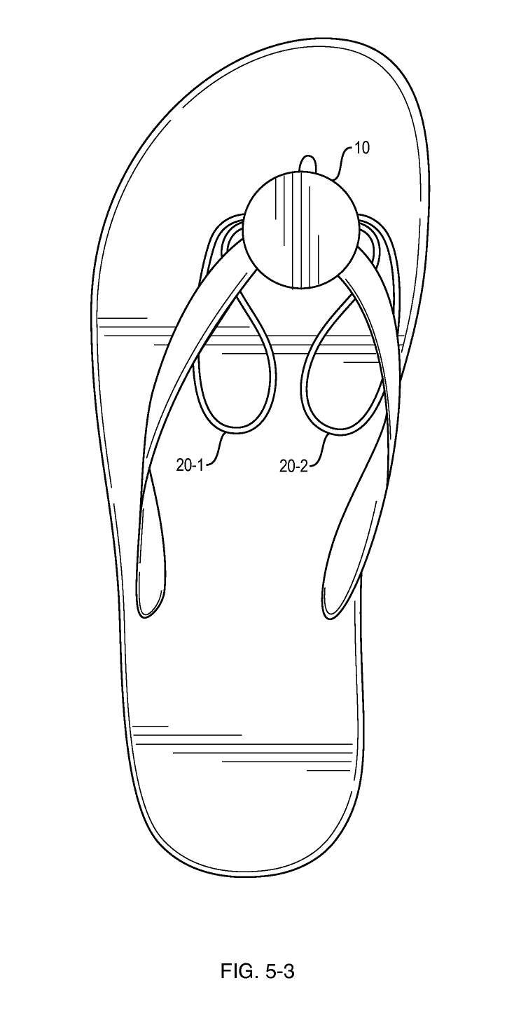

FIG. 4-5 is a top view of the ornament 10 with an elastomeric strap 22-1, 22-2 according to an embodiment of the invention. The elastomeric strap 22-1, 22-2 may be molded rubber, silicone or thermoplastic elastomer. In one example embodiment, the elastomer is made from Santoprene, which can be molded in a clear color.

The ornament 10 may be a plastic molded bezel as shown in FIG. 4-5, which can be manufactured using an injection modeling technique. It should be noted that although the ornament 10 is shown having a bezel, a flat disc would work as well. The bezel provides a standardized means to carry a decoration element. The bezel creates a flat surface with protective sides to attach various decorative elements. The ornament may include a vacuum plated metal finish. The ornament may be painted, plated and/or decorated.

In another embodiment, the ornament 10 may be stamped metal. The metal may be manufactured using progressive die or stage tools, as well as spot welding to attach a button feature/decoration element.

FIGS. 4-6 and 4-7 are side views of an ornament with an interlocking post (coupler) on back according to an embodiment of the invention. The interlocking post/coupler secures an elastomeric strap 22-1, 22-2 for attaching the strap to the ornament 10. It provides an interference fit between a rigid post feature and a hole in the elastomeric strap 22-1, 22-2.

FIG. 4-8 is a bottom view of an ornament 10 with interlocking post on the back according to an embodiment of the invention. FIGS. 4-9 and 4-10 are cross section views of an ornament with interlocking post on back according to an embodiment of the invention. The interlocking post 30-1 provides a snap fit to attach the ornament 10 to the strap element 22-1, 22-2. With the interlocking post 30-1, the pieces interlock with no additional mechanical or chemical fasteners.

### Two Loop System to Form a Single Combined Loop

FIGS. 5-1 through 5-7 are a series of diagrams showing the process of attaching the ornament to the footwear according to the two loop system. The two loop system is preferred, as it holds the ornament in place on the shoe. If the ornament has only one loop, the ornament tends to slip or spin on the strap.

FIG. 5-1 is a diagram of the ornament placed on top of the footwear, the two elastic loops provided according to an embodiment of the invention.

FIG. 5-2 is a diagram of the left elastic fastener wrapping under the shoe strap according to an embodiment of the invention.

FIG. 5-3 is a diagram of the right elastic fastener wrapping under the shoe strap to align with the left elastic fastener according to an embodiment of the invention. The ornament is shown on top of a shoe and the two loops/fasteners are pulled down underneath the ornament on opposite sides of the ornament. The two loops are joined together to form a single loop as shown in FIG. 5-4.

FIG. 5-4 is a diagram of the left and right elastic fasteners aligned together under the straps of the footwear to form a single combined loop according to an embodiment of the invention.

In FIG. 5-5, the single combined loop that has been created flips over to the top of the ornament and secures the ornament to the shoe according to an embodiment of the invention.

Other techniques may involve taking the two loops on each side and individually wrapping them around the ornament. These techniques involve taking each loop individually and securing that respective loop separately around the ornament. There are several disadvantages, however, with such approaches. If one secures each loop individually one at a time, it can cause the ornament to slide to, for example, the wearer's toes. The ornament can slide during the attachment process, or after it has been attached.

Certain embodiments of the present invention addresses such issues of instability of the ornament by meeting the two loops together to form a single combined loop, which is wrapped around the ornament. The present two loop system that forms a single combined loop securely fastens the ornament to the shoe, provides stability from movement, and enables the ornament to be centered during and after attachment.

FIG. 5-5 is a diagram of the two elastic fasteners (now aligned into one combined loop) flipping over the ornament according to an embodiment of the invention.

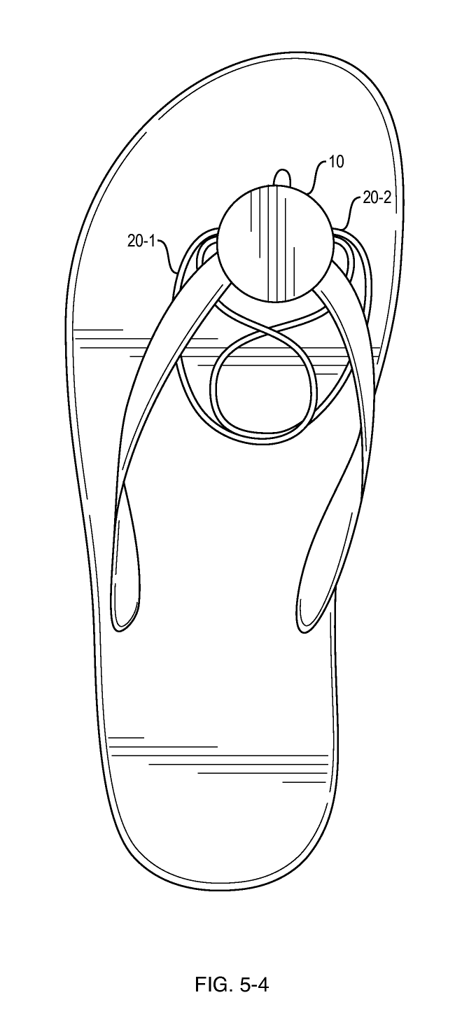

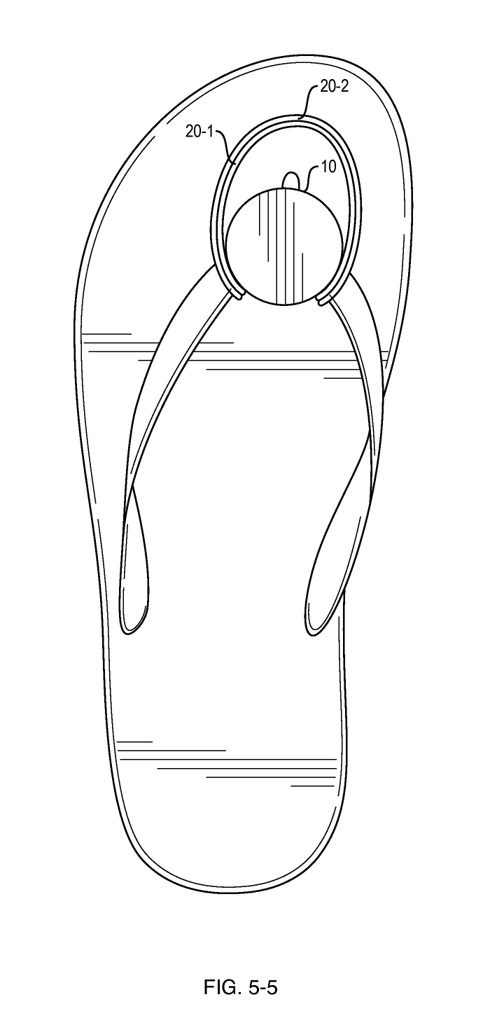

FIG. 5-6 is a diagram showing how the elastic fasteners attach the ornament to the footwear, as though one could see through the ornament according to an embodiment of the invention.

FIG. 5-7 is a diagram showing the ornament completely attached to the footwear, as though one could see through the ornament according to an embodiment of the invention.

FIG. 6 is a diagram showing a front elevation of the ornament fastened to the center/top thong portion of the footwear, secured by the elastic loops which have wrapped around the straps and looped over the ornament itself according to an embodiment of the invention.

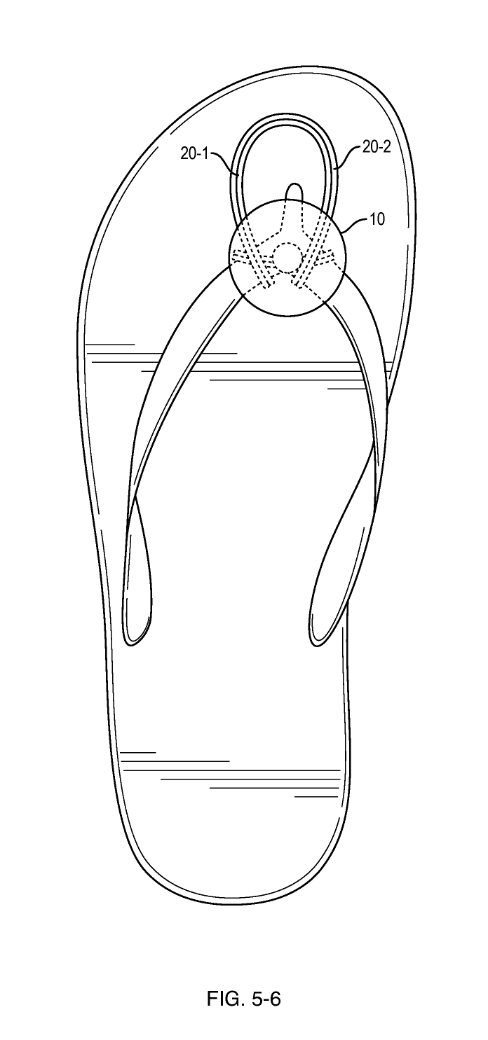

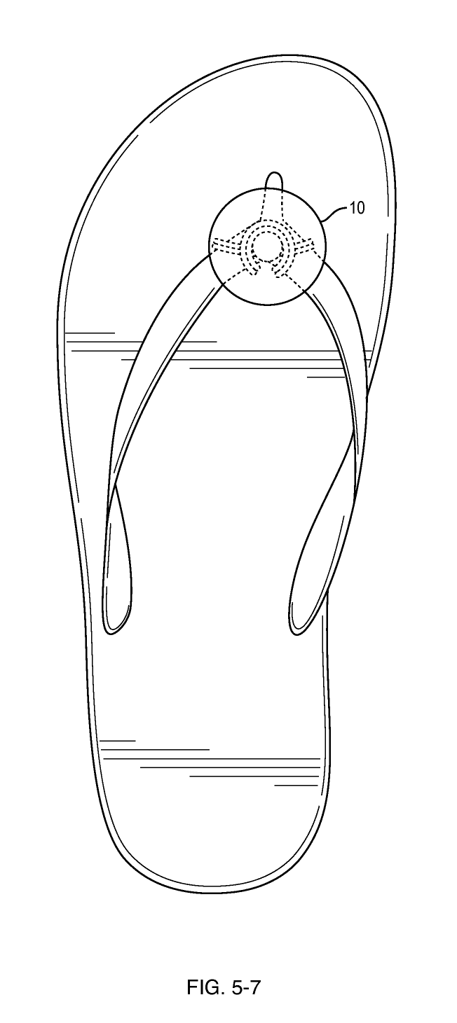

FIG. 7 is a diagram showing a back elevation of the ornament fastened to the footwear, again secured by the two elastic loops, which have been brought together under the thong of the footwear and looped over the ornament to secure the ornament to the center/top thong of the footwear according to an embodiment of the invention.

FIG. 7 is a diagram showing a back elevation of the ornament fastened to the footwear according to an embodiment of the invention.

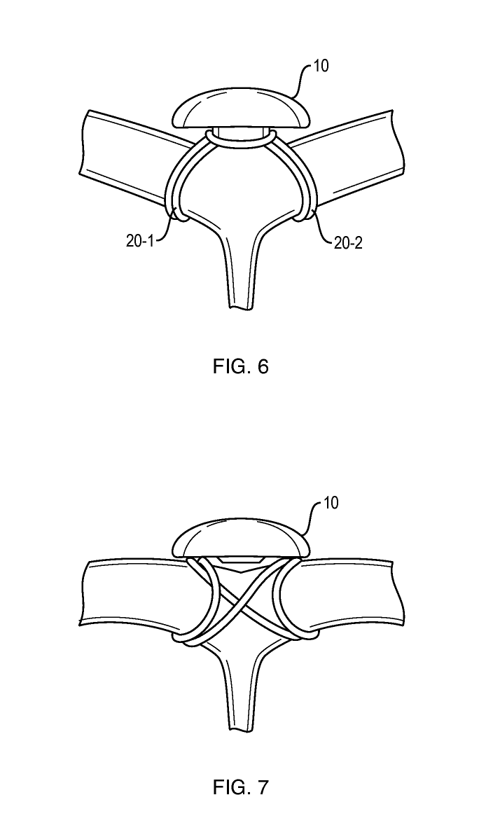

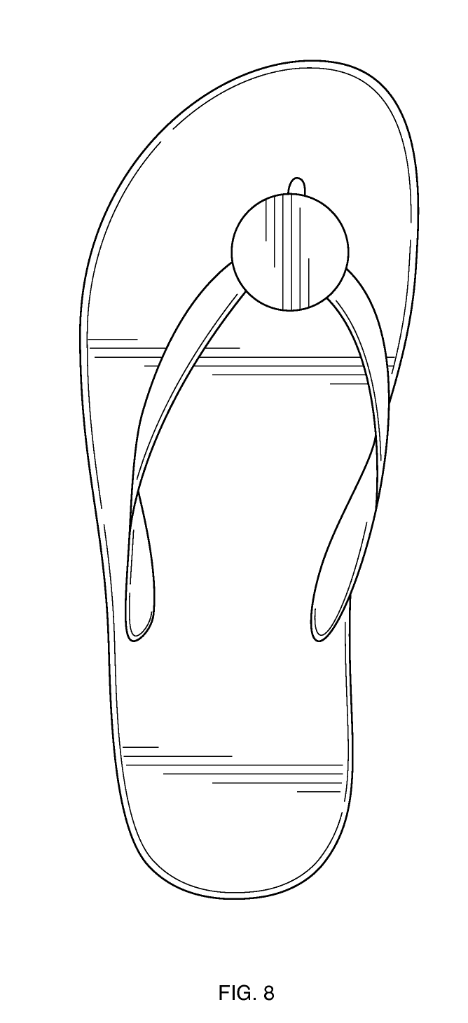

FIG. 8 is a diagram of the ornament attached to the footwear according to an embodiment of the invention.

### Attaching the Accessory System to Other Objects

Although the ornament 10 is described as being implemented in connection with footwear, the accessory system can be attached to other objects. For example, the accessory system can be used as hair decorations/hair bands or rings. The ornament accessory system may also be used on other types of footwear or objects, such as handbags, hair products, zippers, steering wheels, ski poles, ski helmets, goggles, personal electronics, bicycle handle bars and scooters.

In the ski poles implementation, the accessory system can help differentiate the ski poles from other ski poles, thereby assisting the user in quick and easy identification of their equipment. In the ski pole implementation, the two loop method may be used in which the two loops are combined together as one loop prior to attachment. The single combined loop may be placed over the handle of the ski pole to secure the accessory system to the ski pole.

In the personal electronic implementation, the ornament 10 includes onboard electronics including at least one computer processor and a media player enabling playback of music. The media player ornament implementation may be combined with the ski pole implementation such that the media player of the present accessory system may provide playback of music while attached to the user/skier's ski pole.

In a zipper implementation, the accessory system may provide a zipper pull for the zipper. The attachment may be located higher on the ornament (closer to the top on the ornament) so that it lies flat. A lanyard clip to may be provided to the attachment. The elastic band may be pierced through the eye of the zipper to facilitate attachment.

While this invention has been particularly shown and described with references to preferred embodiments thereof, it will be understood by those skilled in the art that various changes in form and details may be made therein without departing from the scope of the invention encompassed by the appended claims.

For example, it should be understood that the ornaments may be made out of any material or combination of materials. The ornaments may be made out of a variety of materials, including hard and soft plastics, wood, fabric, felt, natural shell and metal. In one preferred embodiment, the fasteners are made of fabric covered elastic.

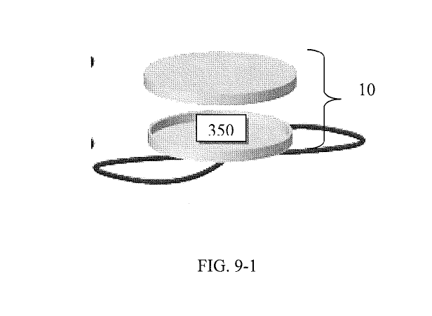

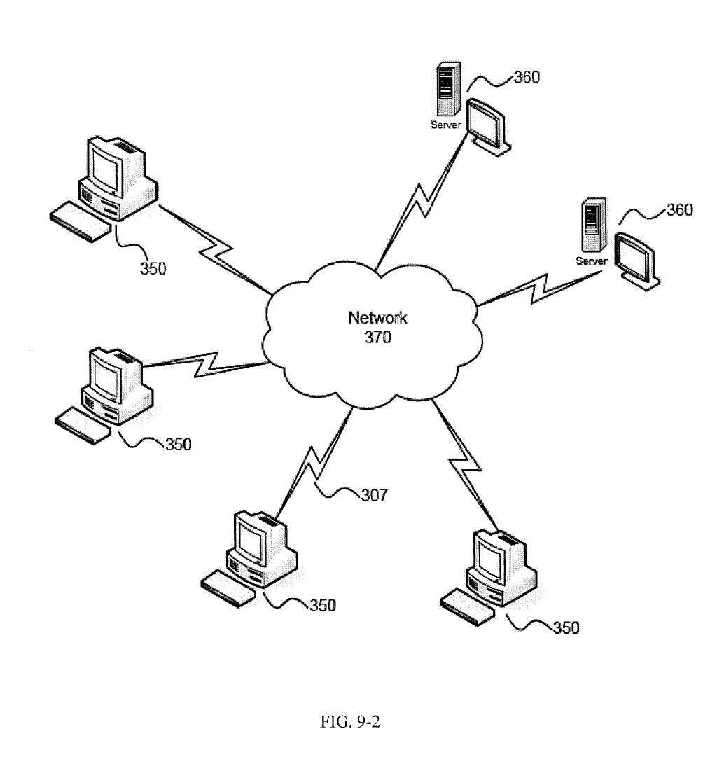

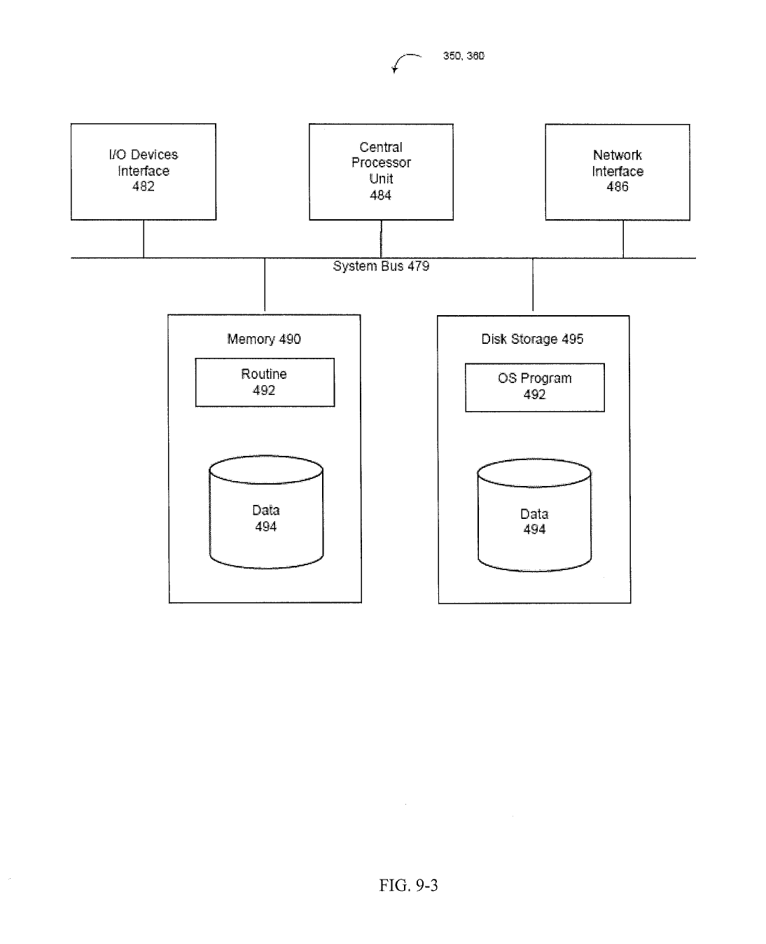

It should be further understood that in the embodiment where the ornament facilitates playback of sound files, the ornament 10 may include components of a computer to perform this feature as shown in FIG. 9-1. FIGS. 9-1 through 9-3 show features related to the embodiment in which the ornament includes a media player (or communication client) and a computer processor for executing the same.

FIG. 9-2 is a diagram of the internal structure of a computer (e.g., client processor/device 350 or server computers 360). Each computer 350 may contain a system bus 479, where a bus is a set of actual or virtual hardware lines used for data transfer among the components of a computer or processing system. Bus 479 is essentially a shared conduit that connects different elements of a computer system (e.g., processor, disk storage, memory, input/output ports, etc.) that enables the transfer of information between the elements. Attached to system bus 479 is I/O device interface 482 for connecting various input and output devices (e.g., ipod, nano, keyboard, mouse, displays, printers, speakers, etc.) to the computer 350, 360. Network interface 486 allows the computer to connect to various other devices attached to a network (for example the network illustrated at 370 of FIG. 3). Memory 490 provides volatile storage for computer software instructions (media player/communication client) 492 and data 494 used to implement an embodiment of the present invention (e.g., sound file playback using a media player). Disk storage 495 provides non-volatile storage for computer software instructions 492 (equivalently “OS program”) and data 494 used to implement an embodiment of the present invention. Central processor unit 484 is also attached to system bus 479 and provides for the execution of computer instructions. Note that throughout the present text, “computer software instructions” and “OS program” are equivalent.

In one embodiment, the processor routines 492 and data 494 are a computer program product/media player (generally referenced 492), including a computer readable medium that provides at least a portion of the software instructions for the invention system. Computer program product 492 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 307 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 492.

In alternate embodiments, the propagated signal is an analog carrier wave or digital signal carried on the propagated medium. For example, the propagated signal may be a digitized signal propagated over a global network (e.g., wireless network or the Internet), a telecommunications network, or other network. In one embodiment, the propagated signal is transmitted over the propagation medium over a period of time, such as the instructions for a software application sent in packets over a network over a period of milliseconds, seconds, minutes, or longer. In another embodiment, the computer readable medium of computer program product 492 is a propagation medium that the computer system 350 may receive and read, such as by receiving the propagation medium and identifying a propagated signal embodied in the propagation medium, as described above for computer program propagated signal product.

What is claimed is:

1. A system of attaching a removable accessory to an item comprising:
an ornament removably attached to a salient portion of an item, the salient portion of the item being capable of receiving the ornament;
the ornament having a coupler coupling a fastener to the ornament;
the coupler having at least two holes;
the fastener having first and second loops, each loop threaded through one or more of the holes on the coupler; and
the first and second loops are wrapped underneath the salient portion of the item to form a single combined loop securing the ornament onto the salient portion of the item, such that the first and second loops are joined together to form the single combined loop that is wrapped over the ornament, where the wrapping of the single combined loop over the ornament causes the ornament to be secured to the salient portion of the item.

2. A system of attaching a removable accessory as in claim 1 wherein the first and second loops are elastic loops.

3. A system of attaching a removable accessory as in claim 1 wherein the fastener is an elastomeric strap made from one or more of: molded rubber, silicone or thermoplastic elastomer.

4. A system of attaching a removable accessory as in claim 1 wherein the coupler includes an interlocking post that secures the fastener to provide a snap fit to attach the ornament to the fastener.

5. A system of attaching a removable accessory as in claim 1 wherein the interlocking post secures the fastener to the ornament without any additional mechanical or chemical fasteners.

6. A system of attaching a removable accessory as in claim 1 wherein the ornament is operable to receive any of a plurality of accessories, each accessory having their own respective design.

7. A system of attaching a removable accessory as in claim 1 wherein the ornament further includes a computer processor, speakers and a media player to facilitate playback of music.

8. A system of attaching a removable accessory as in claim 1 wherein the item is one of the following: a shoe, a ski pole, a handbag, a hair product, a zipper, steering wheel, or a bike handle bar.

9. A system of attaching a removable accessory as in claim 1 wherein the removable accessory is attached to a wearer's body part wherein the body part is one of the following: hair or finger.

10. A method of attaching a removable accessory to a shoe comprising:
creating first and second loops of a fastener by threading the fastener through holes on a coupler attached to an ornament; and
attaching the fastener to a strap of the shoe to facilitate attachment of the ornament to the shoe strap by:
wrapping first and second loops under opposite sides of the strap;
joining the first and second loops under the strap to form a single combined loop; and
pulling over the single combined loop over the top of the ornament to secure the ornament to the shoe, where the single combined loop stabilizes the ornament on the shoe strap and prevents the ornament from moving to one side of the shoe strap.

11. A removable apparatus for accessorizing footwear comprising:
an ornament capable of being removably attached to a portion of a shoe strap;
the ornament having a coupler configured to couple a fastener to the ornament;
the coupler having two holes for threading the fastener through the coupler;
the fastener having a two loop system including first and second loops, each loop being created as a result of threading the fastener through the respective holes on the coupler;
the two loop system configured such that the first and second loops are wrapped underneath the shoe strap to form a single combined loop to facilitate securing the ornament to the shoe strap, where the first and second loops are joined together to form the single combined loop; and
the single combined loop configured to be pulled over the ornament to secure the ornament to the shoe strap.

12. A removable apparatus wherein the fastener is an elastomeric strap made from one or more of: molded rubber, silicone or thermoplastic elastomer.

13. A removable apparatus wherein the coupler includes an interlocking post that secures the fastener to provide a snap fit to attach the ornament to the fastener.

14. A removable apparatus wherein the interlocking post secures the fastener to the ornament without any additional mechanical or chemical fasteners.

15. A method of accessorizing footwear comprising:
enabling an ornament to be removably attached to a portion of a shoe using a fastener having two loops attached to a bottom of the ornament; and
the fastener causing the ornament to rest on an upper portion of the shoe, while the two elastic loops secure the ornament by coming together underneath the shoe, and then joining together and flipping over the ornament to hold the ornament in place.

16. The method of accessorizing footwear as in claim 2 where the two loops secure the ornament by coming together underneath a strap of the shoe.

17. A removable accessory system comprising:
an ornament removably attached to a salient portion of an item, the salient portion of the item being capable of receiving the ornament;
the ornament having a coupler coupling a fastener to the ornament;
the coupler having at least two holes;
the fastener having first and second loops, each loop threaded through one of the holes on the coupler, where the first and second loops secure the ornament to the salient portion of the item; and
the ornament including a media player, speakers and a processor configured to execute the media player to facilitate playback of sound files.

18. A removable accessory system as in claim 16 wherein the first and second loops are wrapped underneath the salient portion of the item to form a single combined loop securing the ornament onto the salient portion of the item, such that the first and second loops are joined together to form the single combined loop that is wrapped over the ornament, where the wrapping of the single combined loop over the ornament causes the ornament to be secured to the salient portion of the item.

19. A removable accessory system as in claim 17 wherein the salient portion of the item is a portion of a handle of a ski pole.

20. A removable accessory system as in claim 17 wherein the salient portion of the item is a portion of goggles attached to a ski helmet.

21. A removable accessory system as in claim 17 wherein the salient portion of the item is a handlebar of a bicycle.

22. A removable accessory system as in claim 17 wherein the ornament is attached to a wearer's body part wherein the salient portion of the body is hair or finger.
